(19) United States
(12) Patent Application Publication
(10) Pub. No.: US 2024/0125146 A1
(43) Pub. Date: Apr. 18, 2024

(54) DOOR ASSEMBLY COMPRISING AN ELECTRICALLY DRIVEN DRIVE ASSEMBLY OF THE DOOR LOCK

(71) Applicant: JELD-WEN TÜREN GMBH, Österreich (AT)

(72) Inventor: Franz BÖHM, Steyr (AT)

(21) Appl. No.: 18/555,592

(22) PCT Filed: Apr. 13, 2022
(86) PCT No.: PCT/AT2022/060115

§ 371 Date: Oct. 16, 2023

(30) Foreign Application Priority Data
Apr. 15, 2021 (AT) A50281/2021

(51) Int. Cl. E05B 47/00; E05B 9/02; E05B 59/00; E05B 63/10

(52) U.S. Cl. CPC E05B 47/0012; E05B 9/02; E05B 59/00; E05B 63/10; E05B 2047/0058; E05B 2047/0061; E05B 2047/0082; E05B 2047/0095

(57) ABSTRACT

The invention relates to a door assembly (1) comprising a door frame (4), a door leaf (6), and a locking system (21) having a door lock (22) and having a drive assembly (25) with an electrically driven drive unit (26) and with an electrical energy source (27). The door lock (22) has a lock case (23) and a locking and/or blocking mechanism (24). The electrically driven drive unit (26), as viewed in the direction of the door leaf thickness (16), is arranged laterally next to and either directly adjacent to the lock case (23) or in the region of a door leaf surface (14, 15) on the door leaf (6), and has a mechanical drive connection with the locking and/or blocking mechanism (24) of the door lock (22).

### CROSS-REFERENCE TO RELATED APPLICATION

This application is a U.S. National-Stage entry under 35 U.S.C. § 371 based on International Application No. PCT/AT2022/060115 filed Apr. 13, 2022, which was published under PCT Article 21(2) and which claims priority to Austrian Application No. A50281/2021, filed Apr. 15, 2021, which are all hereby incorporated in their entirety by reference.

### TECHNICAL FIELD

The invention relates to a door assembly comprising a door leaf and a locking system with a door lock and with an electrically driven drive arrangement.

### BACKGROUND

DE 20 2020 100 649 U1 describes a door lock-spindle insert that is designed to attach a mechatronic knob to it. For its part, the knob is equipped with an electric motor, a drive gear, as well as an electronic control unit and a power source. The mechatronic knob provides intelligent access control for doors. The mechatronic knob and the spindle insert can be offered separately from each other. This arrangement allows for subsequent convenient installation, making it easier for a user to insert the screw into the bore hole. The disadvantage of this is that easy access to the mechatronic knob is possible, which means that manipulations can be carried out unnoticed. In addition, the knob forms a bulky visual appearance.

### SUMMARY

The object of the present invention was to overcome the disadvantages of prior art and to provide a door assembly with an electrically driven locking system, which is better protected against unauthorized access and damage.

This task is solved by a door assembly according to the claims.

The first door assembly according to the invention is provided to be installed in or on a wall opening of a wall. The door assembly comprises
a door frame,
at least one door leaf which defines at least one door leaf, a first door-leaf surface and a second door-leaf surface spaced away from it in a door-leaf thickness, wherein the door leaf is comprehensively delimited by a first longitudinal face side, a second longitudinal face side, a first transverse face side and a second transverse face side, and wherein the door leaf is in connected to the door frame in terms of synchronized movement, and
a locking system that comprises a locking system
   a door lock with a lock case and a locking and/or blocking mechanism, wherein the door lock is inserted into the door leaf in the area of the first longitudinal face side and held positioned on it, and
   a drive arrangement with an electrically driven drive unit and with an electric power source, wherein the electrically driven drive unit is mechanically connected to the locking and/or blocking mechanism of the door lock, wherein it is furthermore provided
that the electrically driven drive unit is positioned to the side of and immediately adjacent to the lock case in the direction of the door-leaf thickness.

The advantage achieved in this way is that at least the majority of the electrically driven drive unit is arranged and accommodated within the door leaf with its door-leaf thickness, but preferably completely. Due to this image and arrangement, the electrically driven drive unit is not visible to a viewer compared to known solutions. This also creates a concealed arrangement when the door leaf is closed, which also prevents manipulation by unauthorized persons. In addition, damage to the drive unit and also the associated component components is also prevented. Another positive aspect is also the overall visual appearance of the door leaf. This is thus kept simple, as the drive components that are otherwise located outside the door leaf are not visible here and motor-driven actuating movements starting from the electrically driven drive unit can still be exerted on the locking and/or blocking mechanism of the door lock. Standardized door locks are also used, which are at least supplemented with the electrically driven drive unit located directly adjacent to it. It is only necessary to provide or develop the necessary holding space within the door leaf.

The second door assembly according to the invention is provided to be installed in or on a wall opening of a wall. The door assembly comprises
a door frame,
at least one door leaf which defines at least one door leaf, a first door-leaf surface and a second door-leaf surface spaced away from it in a door-leaf thickness, wherein the door leaf is comprehensively delimited by a first longitudinal face side, a second longitudinal face side, a first transverse face side and a second transverse face side, and wherein the door leaf is in connected to the door frame in terms of synchronized movement, and
a locking system that comprises a locking system
   a door lock with a lock case and a locking and/or blocking mechanism, wherein the door lock is inserted into the door leaf in the area of the first longitudinal face side and held in position on it, and
   a drive arrangement with an electrically driven drive unit and with an electric power source, wherein the electrically driven drive unit is mechanically connected to the locking and/or blocking mechanism of the door lock, wherein it is furthermore provided
that the electrically driven drive unit is located on the side of the lock case and in the area of one of the door-leaf surfaces on the door leaf in the direction of the door-leaf thickness.

The advantage achieved by this is that at least the electrically driven drive unit is located directly on the door leaf. The housing of the electrically driven drive unit or a possible cover element protects the drive mechanism from unauthorized access or unwanted damage, as this design has only a small supernatant over the door leaf. The installation space between the lock follower with the door handle that can be located there, where applicable, and the lock cylinder serves as a holding space for the electrically driven drive unit with its drive mechanism. Another positive aspect is also the overall visual appearance of the door leaf. This is thus kept simple, as the drive components that are otherwise located on the lock cylinder and project far beyond the door leaf are located directly on the door leaf, in particular, held in the cover element, and motor-driven actuating movements starting from the electrically driven drive unit can still be exerted on the locking and/or blocking mechanism of the door lock. Standardized door locks are also used, which are at least supplemented with the adjacent electrically driven drive unit.

Furthermore, it can be favourable if the electrically driven drive unit is held in a fixed position on the lock case. This makes it possible to achieve a torque-proof and stable connection of the drive unit to or from the lock case. Furthermore, the required space requirement can also be kept as low as possible.

Another design requires that the electrically driven drive unit is housed in the door leaf and that the majority of it is located within it. In this way, it is protected, and the associated unwanted and unauthorized handling of the drive unit can be prevented. In addition, a visually simple appearance can also be achieved while avoiding more complex external components.

Another embodiment is characterized in that the electrically driven drive unit is held in a stationary manner on the door-leaf surface of the door leaf. In this way, a safe and permanent arrangement of the drive unit on the door leaf can be established.

Another embodiment is characterized in that the locking system comprises a lock cylinder, which lock cylinder is mounted in a cylinder perforation located in the lock case, and the electrically driven drive unit is mechanically driven via the lock cylinder with the locking and/or blocking mechanism of the door lock. In this way, the direct drive connection can be established within the door leaf, by means of which the necessary rotational movement of the lock cylinder can be transferred to the locking and/or blocking mechanism.

Another possible embodiment has the features that the electrically driven drive unit is mechanically connected to the locking and/or blocking mechanism of the door lock via a lock follower of the door lock. Even with this possible arrangement variant, an automated actuation of the door lock can be achieved by means of the electrically driven drive unit. However, a specially designed door lock with the appropriate locking and/or blocking mechanism must be used.

Another embodiment is characterized in that the electrically driven drive unit is covered by a cover element in the area of one of the door-leaf surfaces. This allows a simple design to be achieved. In addition, it can be made possible to provide access to the drive unit when the cover element is removed. Furthermore, the insertion and/or assembly of the drive unit from the flat side of the door leaf can also be made possible and, where applicable, also be facilitated. The electrically driven drive unit can optionally be arranged on one side of the lock case facing the respective door-leaf surfaces. However, it would also be possible to insert the drive unit into the door leaf starting from the first longitudinal face side.

Another design requires that the electrically driven drive unit is arranged within the cover element and held in a fixed position on it. In this way, a cohesive construction unit consisting of a cover element and drive unit can be created, which provides good protection against damage and unwanted access.

Another preferred embodiment is characterized in that the drive arrangement also comprises a manually operated actuating element, which actuating element is located on the side of the electrically driven drive unit facing away from the lock case and is mechanically connected to the locking and/or blocking mechanism of the door lock. This makes it possible to manually operate the locking and/or blocking mechanism in addition to the motor-driven adjustment movement.

Furthermore, it can be favourable if the manually operated actuating element projects over the cover element on the side facing away from the lock case. This makes it easier to grasp and actuate, i.e., the rotational movement on the lock cylinder.

Another alternative embodiment is characterized in that the manually operated actuating element projects through the cover element. In this way, a drive connection with the drive unit and, furthermore, to the lock cylinder can be implemented.

Another possible and, where applicable, alternative embodiment comprises the features that the electrical power source is designed as an electrical power storage device and the electrical power storage device is held in the door leaf. In this way, an assembly that is protected and, above all, that is protected against unauthorized operation can also be achieved for this component of the locking system.

Another design requires that the electrical power storage device is held in a fixed position on the lock case. In this way, a cohesive and compact component of the locking system can be created.

Another embodiment is characterized in that the door leaf comprises a receptacle recess in the area of its first longitudinal face side and the electrical power storage device is located in the receptacle recess. On the one hand, this allows a spatially protected arrangement to be created and, on the other hand, a position that is easily accessible when the door leaf is open.

Another preferred embodiment is characterized in that the locking system comprises a contactless electrical transmission device with a first transmission element and a second transmission element, and the first transmission element is arranged in the area of the first longitudinal face side of the door leaf and, when the door leaf is closed, the second transmission element is arranged in the area of a right or left frame section located immediately opposite the first longitudinal face side of the door frame, and the first transmission element is connected in an electrically conductive manner to the electrical power storage device. By choosing the contactless electrical transmission device, electrical power can be transferred from one transmission element to another without contact, in particular by means of induction. In this way, when the door leaf is closed, it is possible to transmit electrical power for the charging process and thus ensure safe operation of the locking system.

Furthermore, it can be favourable if the locking system comprises an electrical connection device, which electrical connection device is arranged in the area of the first door-leaf surface and is connected in an electrically conductive manner to the electrical power storage device. In this way, if the electrical power storage device is designed to be rechargeable, a charging process can be carried out as required. For this purpose, for example, a charging voltage adapted to the electrical power storage device as well as an adapted charging current must be applied to the electrical connection device. This can be, for example, a USB port or other electrical coupling device.

Another alternative embodiment is characterized in that the electrical power storage device is selected from the group: accumulator, battery, capacitor. This means that the appropriate electrical power storage device can be selected for each application.

Another possible and, where applicable, alternative embodiment has the features that the drive arrangement comprises a first communication unit and a second communication unit interacting with it, which first communication unit is at least designed to receive commands generated by the second communication unit and transmit them to the electrically driven drive unit for their operation. This makes it possible to realize a so-called remote control. Depending on the type of communication chosen and the associated control and/or program logic, it can also be possible to monitor the locking system.

### BRIEF DESCRIPTION OF THE DRAWINGS

For a better understanding of the invention, it is explained in more detail on the basis of the following figures.

In each case, they show in a highly simplified, schematic illustration:

FIG. 1 a door assembly with a door frame, a door leaf and a locking system with a door lock and a drive arrangement with an electrically driven drive unit and with an electric power source as an illustration;

FIG. 2 a section of the door leaf in the area of the door lock, with a first exemplary arrangement of the drive arrangement in a front view sectioned in accordance with lines in FIG. 1;

FIG. 3 another possible exemplary arrangement of the drive arrangement in the area of the door lock in a front view sectioned in accordance with lines II-II in FIG. 1;

FIG. 4 view of a door lock designed as a lock with a multipoint-locking system;

FIG. 5 the lock with a multipoint-locking system in accordance with FIG. 4 in front view in accordance with arrow V in FIG. 4;

FIG. 6 a top view of the lock with a multipoint-locking system in a top view sectioned in accordance with FIGS. 4 and 5, in accordance with lines VI-VI in FIG. 4;

FIG. 7 a first exemplary arrangement of the locking system, in which the electric drive unit is connected to the locking and/or blocking mechanism by means of the lock cylinder in a view sectioned in accordance with lines VII-VII in FIG. 8;

FIG. 8 the locking system in accordance with FIG. 7 in a top view in accordance with lines VIII-VIII in FIG. 7;

FIG. 9 a second exemplary arrangement of the locking system, in which the electric drive unit is connected to the locking and/or blocking mechanism by means of the lock cylinder in a view sectioned in accordance with lines IX-IX in FIG. 10;

FIG. 10 the locking system in accordance with FIG. 9 in a top view sectioned in accordance with to the lines X-X in FIG. 9;

FIG. 11 a third exemplary arrangement of the locking system, in which the electric drive unit is connected to the locking and/or blocking mechanism via the lock follower in a view sectioned in accordance with lines XI-XI in FIG. 12;

FIG. 12 the locking system in accordance with FIG. 11 in a top view sectioned in accordance with lines XII-XII in FIG. 11;

FIG. 13 a fourth exemplary arrangement of the locking system, in which the electric drive unit is connected to the locking and/or blocking mechanism via the lock follower in a view sectioned in accordance with lines XIII-XIII in FIG. 14;

FIG. 14 the locking system as shown in FIG. 13 in a top view sectioned in accordance with lines XIV-XVI in FIG. 13;

FIG. 15 another section of the door leaf in the area of the door lock, with another possible exemplary arrangement of the drive arrangement in a front view sectioned in accordance with lines II-II in FIG. 1;

FIG. 16 another section of the door leaf in the area of the door lock, with a possible further exemplary arrangement of the drive arrangement in a front view sectioned in accordance with lines II-II in FIG. 1.

### DETAILED DESCRIPTION

At this point, it should be noted that in the differently described embodiments, identical parts are provided with the same reference numbers or the same component designations, wherein the disclosures contained in the entire description can be transferred mutatis mutandis to identical parts with the same reference numbers or the same component designations. Also, the position specifications selected in the description, such as top, bottom, side, etc., are related to the directly described and depicted figure, and in the event of a change of position, these position specifications must be transferred mutatis mutandis to the new position.

The term ‘in particular’ is hereinafter understood as meaning that it can refer to a possible more specific design or further specification of an object or a method step, but does not necessarily have to be a mandatory, preferred embodiment of the same or a mandatory approach.

In their present use, the terms ‘having’, ‘comprises’, ‘comprising’, ‘includes’, ‘including’, ‘contains’, ‘containing’ and any variations thereof are intended to cover inclusion deemed to not be exclusive.

Another term that can also be used is “optional”. This means that this method step or system component is basically available but can be used depending on the conditions of use, but this does not necessarily have to be done.

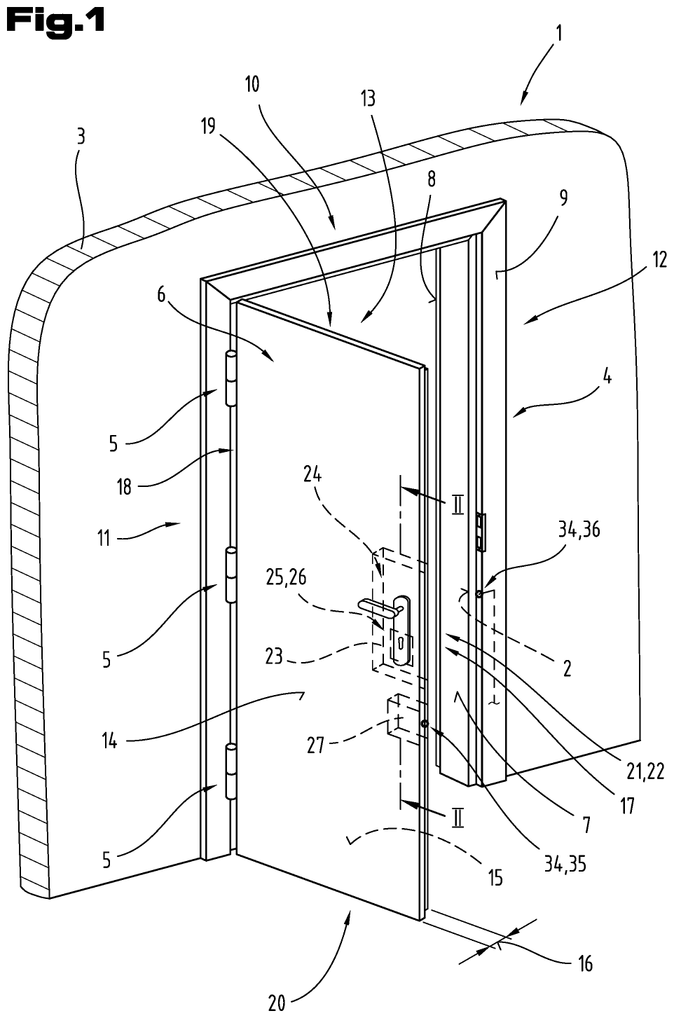

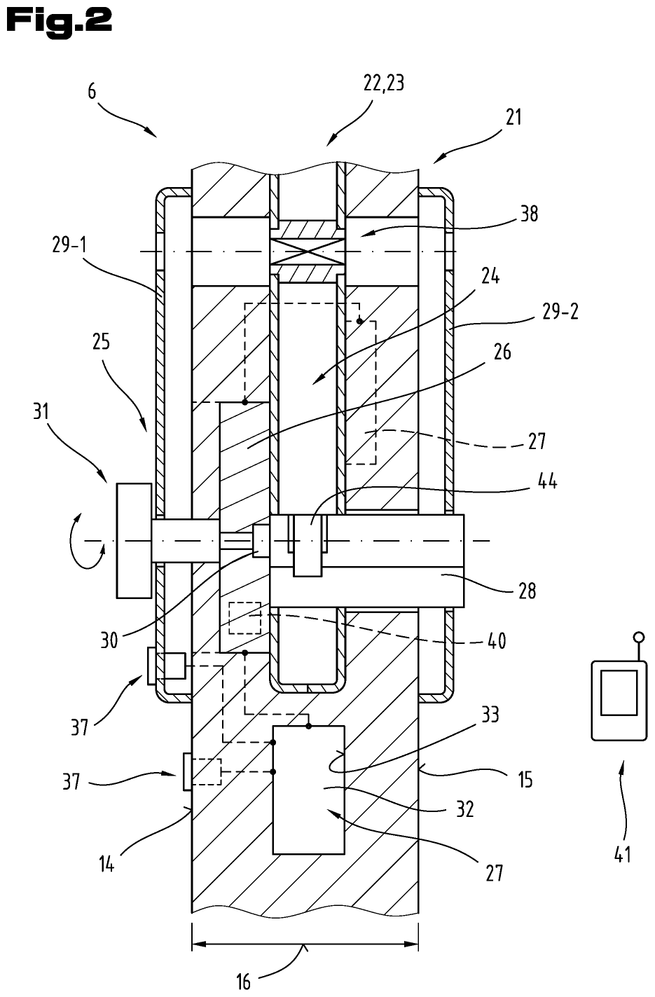

FIG. 1 and the other FIGS. 2, 3, 15 and 16 show a door assembly 1 or a part of it, which is intended to be installed in a wall opening 2 or on a wall 3 around wall opening 2. The door assemblies 1 can be designed in a wide variety of ways, wherein the embodiment variants described below entail a single-leaf door assembly 1. However, it would also be possible to provide for multi-leaf door assemblies 1, a sliding door assembly or the like.

The door assembly 1 essentially comprises a frame, in particular, a door frame 4, and a door leaf 6, which can be swivelled on door frame 4 via door hinges 5—this only applies to hinged doors. Door hinges 5 together form a swivel unit for door leaf 6. It would also be possible to provide only a single upright element instead of door frame 4 and to place door leaf 6 on it in a swivel manner by means of preferably a plurality of door hinges 5.

In this exemplary embodiment shown here, a complete door frame 4 is provided, which includes a lining board 7 as well as adjoining cladding elements on both sides. This can be a decorative cladding element 8 as well as a rebate cladding element 9, which, together with the lining board 7, can enclose or encroach the wall 3 or the masonry in a U-shaped arrangement. The lining board 7 can also be referred to as stock lining. A simplified embodiment of door frame 4 was chosen for the illustration.

Door frame 4 itself comprises a horizontally aligned upper or first frame section 10, a left frame section 11 and a right frame section 12 when installed in or at wall opening 2. The left and right frame sections 11 and 12 each have a vertical orientation when installed and, together with the first frame section 10, thereby enclose a passage opening 13. It would also be possible to extend the left and right frame sections 11, 12 all the way to the top and to dispense with the upper or first frame section 10. Furthermore, depending on the opening direction of door leaf 6, only the left frame section 11 or the right frame section 12 with the door hinges 5 supporting the door leaf 6 could also be provided.

This exemplary embodiment shown is a so-called folded door assembly 1. It should be mentioned that the arrangement and design of the frame can be chosen in a wide variety of ways. Likewise, the design of door leaf 6 as a rebated door is not restrictive, but it can be a matter of a wide variety of door leaf designs. For example, door leaf 6 can also be designed as a seamless door leaf 6 or also as a swinging door or sliding door. Depending on the design of door leaf 6, it is connected to door frame 4 in terms of synchronized movement or is swivel-mounted on a component of the same or guided in a linear manner. In the example shown in FIG. 1, door leaf 6 is swivelled on the left-hand side of frame section 11. A mirror-image bearing assembly is possible and also common if required.

The door leaf 6 itself can be constructed in a variety of ways. Generally, the door leaf 6 is delimited on its two opposite flat sides by a first door-leaf surface 14 and a second door-leaf surface 15, wherein a door-leaf thickness 16 extending between the two door-leaf surfaces 14, 15 is defined. For the sake of simplicity, a flat design of the two door-leaf surfaces 14, 15 was chosen, wherein additional elevations and/or recesses on or in the door leaf 6 can also be provided.

Furthermore, the door leaf 6 is delimited comprehensively and on the edge side by a first longitudinal face side 17, a second longitudinal face side 18 arranged opposite to these and a first transverse face side 19 as well as a second transverse face side 20 arranged opposite them. The two transverse face sides 19 and 20 extend between the two longitudinal face sides 17 and 18.

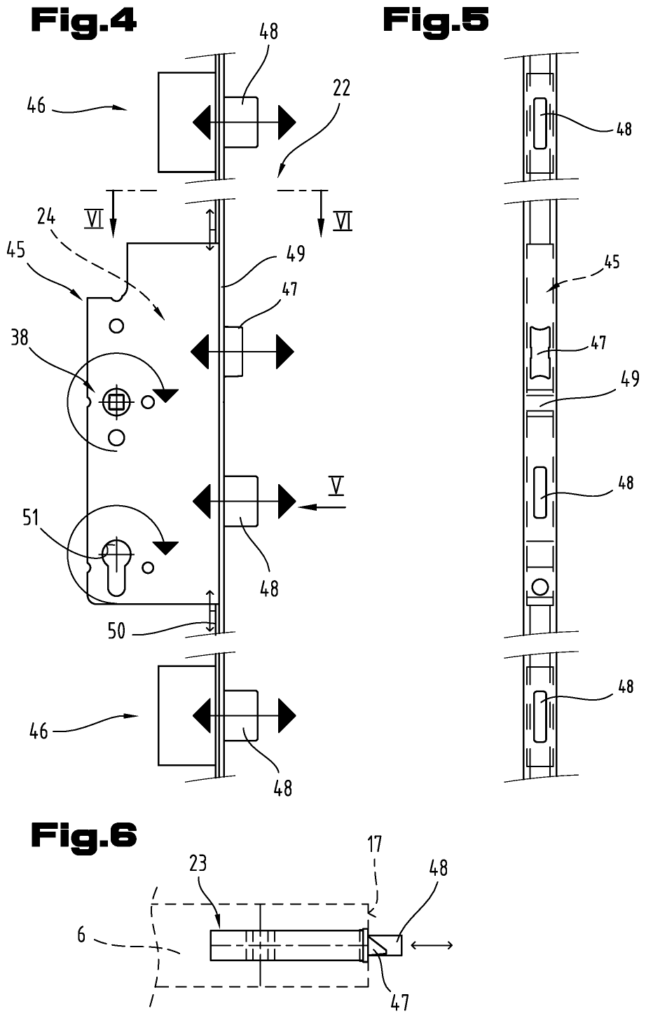

Furthermore, door assembly 1 also includes a locking system 21, which can be designed in a wide variety of embodiment variants. The locking system 21 includes a door lock 22, which can also be referred to as a mortice lock or mortise lock. It can be a main lock or also a lock with a multipoint-locking system with a main lock case and at least one secondary lock case. Each secondary lock case has at least one secondary bolt, which can be moved together with the main bolt between a release position and a blocking/locking position. A possible exemplary embodiment of a lock with a multipoint-locking system is shown and described in more detail in FIGS. 4 to 6.

Usually, the door lock 22 comprises a lock case 23, a cuff (not specified here), and a locking and/or blocking mechanism 24, the majority of which are located within the lock case 23. These can include the lock latch, the lock follower, the lock bolt and the tumbler. The lock follower is used to unlock the lock latch on door frame 4 in order to be able to subsequently open door leaf 6. In the area of door frame 4, a so-called strike plate is preferably provided or arranged, which at least engages with the lock latch and/or the lock bolt when door leaf 6 is closed and also locked.

In a known way and as shown in the present exemplary embodiment, the door lock 22 is inserted into the door leaf 6 in a specially designed door lock recess in the area of the first longitudinal face side 17 and held positioned on the door leaf 6. The lock case 23 can also be referred to as the main lock case, wherein in the case of a lock with the multipoint-locking system, at least one additional lock case or secondary lock case can also be provided in addition to the main lock case. For this purpose, the cuff must be designed with a larger longitudinal extension. The locking devices in the secondary lock cases are operated from the main lock case via a drive rod almost congruent under the cuff.

In the present exemplary embodiment, door leaf 6 is to be opened in the direction of an unspecified interior or living space. In order to ensure that it is not necessary to only manually open or close the door assembly 1, i.e., when the door position of door leaf 6 is closed, by means of door lock 22 with its locking and/or blocking mechanism 24, an additional drive arrangement 25 is provided here, which can transmit the necessary actuating movements to the locking and/or blocking mechanism 24 of the main lock case by means of provided electrical power and carry them out by means of it. The drive arrangement 25 can include, among other things, an electrically driven drive unit 26 and an electric power source 27. Such electric drive units 26 usually comprise an electric motor, a gear assembly and a mechanical coupling means for transmitting a rotational drive torque to the locking and/or blocking mechanism 24. For example, the electric drive unit 26 can have or establish a mechanical drive connection with the locking and/or blocking mechanism 24 of the door lock 22.

In the following, possible examples of the arrangement of the drive arrangement 25 with its individual components on or in the door leaf 6 and the interaction with the locking and/or blocking mechanism 24 of door lock 22 are shown and described.

In FIG. 2, the arrangement of the drive arrangement 25, in particular, the arrangement of its electric drive unit 26, with respect to the lock case 23, is shown in a highly simplified manner in a cross-sectional illustration running in parallel with respect to the first longitudinal face side 17 through the door leaf 6. It should be noted that for the sake of clarity, the door-leaf thickness 16 of door leaf 6 has been greatly enlarged. Furthermore, the illustration of the structure or the design of door leaf 6 in its interior was dispensed with. The lock case 23 of the door lock 22 is held in the door lock recess described above, but not specified in more detail.

For reasons of clarity, door lock 22 is shown only with its lock case 23, but without the locking and/or blocking mechanism 24 contained therein. The locking and/or blocking mechanism 24 can be designed in accordance with known prior art. Furthermore, it is indicated that the locking system 21 for the actuation of the locking and/or blocking mechanism 24 can include a lock cylinder 28. The lock cylinder 28 can be designed in a wide variety of ways, depending on your needs. For example, it can be designed as a so-called half-cylinder, as a half-cylinder with a coupling element designed to absorb torque or the like.

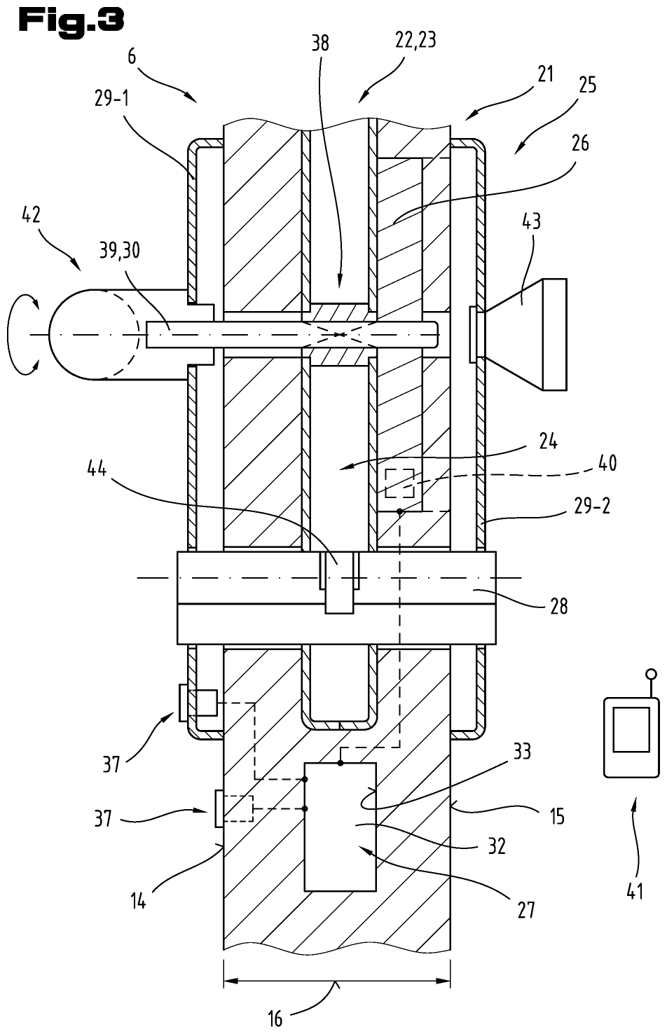

In this exemplary embodiment and also in the subsequent further exemplary embodiments in FIGS. 3 and 7 to 14, it is always provided that the electrically driven drive unit 26 is arranged in the direction of the door-leaf thickness 16 to the side of and immediately adjacent to the lock case 23 and a predominant part, but preferably all of it, is arranged within the door leaf 6. Here, the electrically driven drive unit 26 is arranged on the side of lock case 23, which faces the first door-leaf surface 14 and thus the living or interior area. Furthermore, the electrically driven drive unit 26 is mechanically driven via the lock cylinder 28 with the locking and/or blocking mechanism 24 of the door lock 22.

Independently of this, however, it would also be possible to arrange the electrically driven drive unit 26 on the side of the lock case 23 that faces the second door-leaf surface 15 and is therefore on the side facing away from the living or interior area.

In order to ensure a relatively torque-proof positioning of the electrically driven drive unit 26 in relation to the lock cylinder 28, which is held in a torque-proof position in lock case 23, the electrically driven drive unit 26 is preferably held in a fixed position on lock case 23, in particular, attached to it. The illustration of holding or fasteners between the drive unit 26 and the lock case 23 has been dispensed with. This can be done, for example, in a positive-locking manner and/or force-fit manner. However, it would also be possible to design or provide a receptacle recess, receptacle opening or the like within the door leaf 6 that is adapted to the external dimensions of drive unit 26.

The receptacle recess or the receptacle opening can be incorporated into the door leaf 6 starting from the first longitudinal face side 17 and/or starting from the door-leaf surface 14 or 15 which is closer to or facing the electrically driven drive unit 26 and thus arranged therein. Depending on the dimensions and size of the electrically driven drive unit 26, the necessary receptacle recesses, notches or cavities must be designed within the door leaf 6. If the electrically driven drive unit 26 is inserted into the door leaf 6 starting from the first longitudinal face side 17, there is no need to take into account the visibility and the possible covering required in the area of the respective door-leaf surface 14 and/or 15.

If, on the other hand, the electrically driven drive unit 26 is inserted into the door leaf 6 starting from one of the door-leaf surfaces 14 or 15; its dimensioning must be carried out in coordination with a cover element 29 used in each case. The area of cover element 29 shall be dimensioned in such a way that at least the receptacle recess, recess, insertion or receptacle opening for the electrically driven drive unit 26 located within the door leaf 6 is covered.

Furthermore, the electrical power source 27 can be spatially separated from the electrically driven drive unit 26 preferably located in or within the door leaf 6. This means that the electrically driven drive unit 26 can be designed with a small space requirement in terms of its external dimensions. For example, it is preferable to hold the electrically driven drive unit 26 in the door leaf 6 or inside of the door leaf 6, and therefore, this can be or will be arranged for the most part within the latter.

Furthermore, the electrically driven drive unit 26 can also reach up to the first door-leaf surface 14, as indicated by dashed lines. It would also be possible to slightly project the first door-leaf surface 14 to the side or direction facing away from the lock case 23. In this case, the electrically driven drive unit 26 can or should be covered by a cover element 29-1 in the area of the first door-leaf surface 14. The electrically driven drive unit 26 is thus located between the lock case 23 and the cover element 29-1 in the direction of the door-leaf thickness 16.

Another cover element 29-2 can also be provided or arranged in the area of the second door-leaf surface 15 opposite the first door-leaf surface 14. The respective cover element 29 can be designed as a single piece as well as consisting of a plurality of parts, for example, as a elongated plate and/or as a rosette.

For the sake of clarity, the illustration of door handles, a doorknob or the like has been dispensed with in FIG. 2. For example, each side of the door leaf 6 can have its own door handles. However, there can also be or will be a door handle only on one side of the door and a doorknob or the like on the other, opposite side of the door.

At least one transmission element 30 can be provided for the transfer of the rotational drive torque from the electrically driven drive unit 26 to the lock cylinder 28 and from the latter to the locking and/or blocking mechanism 24. The transmission element 30 can be formed by a key, an adapter or the like, for example. A torque-proof connection or mechanical coupling from the electrically driven drive unit 26 to the lock cylinder 28 must be ensured. As is well known, the lock cylinder 28 itself has at least one specially designed actuating means 44, which can be brought into a mechanical intervention with the locking and/or blocking mechanism 24 located in lock case 23 or interacts with it.

As provided in this exemplary embodiment, the electrically driven drive unit 26 is arranged on the side of door leaf 6 facing the living area in relation to lock case 23. In order to enable manual and/or keyless operation of the locking and/or blocking mechanism 24 of the door lock 22 from this door side, the drive arrangement 25 can also have a manually operated actuating element 31.

As can be seen from the simplified diagram in FIG. 2, the actuating element 31 is located on the side of the electrically driven drive unit 26 facing away from the lock case 23 and is also mechanically connected via the electrically driven drive unit 26 with the locking and/or blocking mechanism 24 of the door lock 22. The manually operated actuating element 31 can also project over the cover element 29-1 on the side facing away from lock case 23. This makes it easy to use. The actuating element 31 can be designed as a wheel or disc. Depending on the design and spatial design of the actuating element 31, it can project through the cover element 29-1. Furthermore, the manually operated actuating element 31 can push through the electrically driven drive unit 26 and/or at least have a rotational drive connection with the transmission element 30.

For example, the electrical power source 27 described above for the supply of electrical power for the drive of the electric motor of the electrically driven drive unit 26 can be done directly to a power grid by means of an electrical line connection. However, the electrical power source 27 is preferred as an electrical power storage device 32. Thereby, it can be selected from the group: accumulator, battery, capacitor or the like. The arrangement of the electrical power storage device 32 on door leaf 6, but preferably within the door leaf 6, can be carried out in such a way that, like door lock 22, it is inserted into door leaf 6 in the area of the first longitudinal face side 17 and is held within it. Preferably, the receptacle recess, the recess or the recess for the power storage device 32 is located adjacent to the door lock recess for the lock case 23, wherein it is possible to touch and/or overlap each other. This means that the effort required for the cabling and electrically conductive connection within the door leaf 6 can be kept relatively low.

One possibility of arrangement is to keep the electrical power storage device 32 stationary directly on lock case 23, as indicated in dashed lines on the right-hand side of door lock 22. It would also be possible to place both the electrically driven drive unit 26 as well as the electric power storage device 32 on the same side of lock case 23 and preferably stick to it. The electrical wiring connection was also indicated in dashed lines.

Another way of accommodating and arranging the electrical power storage device 32 within the door leaf 6 is to provide or form a separate receptacle recess 33 in the area of the first longitudinal face side 17 of door leaf 6. Starting from the first longitudinal face side 17, the electrical power storage device 32 can then be inserted into the receptacle recess 33. The electrical wiring connection was also indicated in dashed lines. The cover in the area of the longitudinal face side 17 can be done by means of a separate cover element and/or also with the cuff of the door lock 22.

Depending on the choice and design of the electrical power storage device 32, it must be possible to change and/or exchange it. In the case of a rechargeable electrical power storage device 32, an appropriate supply of electrical power for charging must be provided or set up.

FIG. 1 indicates a simplified indication of a first possibility. For this purpose, the locking system 21 comprises a contactless electrical transmission device 34 with a first transmission element 35 and a second transmission element 36. The two transmission elements 35 and 36 are designed for this purpose and positioned in their relative position in relation to each other in such a way that, when door leaf 6 is closed, the contactless transmission of electrical power from the second transmission element 36 located on door frame 4 to the first transmission element 35, which is located in the area of the first longitudinal face side 17, takes place or can take place. The supply of electrical power to the second transmission element 36 is implemented by means of a cable connection indicated in dashed lines. Yes, depending on the opening direction of door leaf 6, the second transmission element 36 can be located either on the right frame section 11 or on the left frame section 12. The first transmission element 35 is connected in an electrically conductive manner to the electrical power storage device 32.

In FIG. 2, another possibility for the supply or supply of electrical power to the electrical power storage device 32 is indicated in simplified terms. For this purpose, the locking system 21 can comprise an electrical connection device 37. Preferably, the electrical connection device 37 is located in the area of the first door-leaf surface 14—i.e., on the side facing the living space and connected in an electrically conductive manner to the electrical power storage device 32. For example, as an electrical connection device 37, a socket, a plug or the like can be provided. It can be arranged or fastened directly to or within the door leaf 6 itself and/or also on the cover element 29-1.

Above the lock cylinder 28, a lock follower 38 is indicated, into which a rotational movement can usually be introduced by means of a square shaft of the door handle(s) and be further transferred to the locking and/or blocking mechanism 24.

FIG. 3 shows a further and, where applicable, independent embodiment of door assembly 1 with its locking system 21, wherein, in turn, the same reference numbers or component designations are used for identical parts as in the preceding FIGS. 1 and 2. In order to avoid unnecessary repetition, reference is made to the detailed description in the preceding FIGS. 1 and 2. Furthermore, in contrast to the previously described arrangement of the electrically driven drive unit 26 on the side of the door lock 22 facing the living area, the arrangement on the side of the living area facing away from it is shown here. The electrically driven drive unit 26 is thus arranged on the side of the door lock 22 facing the second door-leaf surface 15. However, it would also be possible to arrange it on the side of the door lock 22 facing the first door-leaf surface 14.

Here, the door assembly 1 with its door frame 4, door leaf 6 and locking system 21 is also provided. The basic structure of the individual components can be done here in an equivalent way, as has already been described in detail before. The door lock 22 with the lock case 23, the locking and/or blocking mechanism 24 and also with the drive arrangement 25 with its electrically driven drive unit 26 and the electrical power source 27 are also provided or present. The arrangement of the electric drive unit 26 with respect to the lock case 23 differs from the first exemplary embodiment described in FIG. 2.

The electrically driven drive unit 26 is, in turn, arranged in the direction of the door-leaf thickness 16 to the side of and immediately adjacent to the lock case 23. Preferably, the electrically driven drive unit 26 is held in a fixed position on lock case 23.

In contrast to the exemplary embodiment described earlier in FIG. 2, the electrically driven drive unit 26 is connected to the lock follower 38 of the door lock 22 and not to the lock cylinder 28. In this way, the rotational drive torque can be transferred from the electrically driven drive unit 26 to the locking and/or blocking mechanism 24 of the door lock 22 via the lock follower 38. In order to transfer the unlocking and/or locking movements to the lock latch and/or to the lock bolt, the locking and/or blocking mechanism 24 must be designed accordingly. This door lock 22 is referred to as the so-called handle-operated door lock 22. By actuating a door handle 42, which is usually located on the inside of the living area, not only the lock latch, but at least also the lock bolt is operated by means of the locking and/or blocking mechanism 24 and adjusted relative to the lock case 23. An actuating rod 39, which is usually designed as a square shaft and is connected to the door handle 42, pushes through the electrically driven drive unit 26 and is also connected to the lock follower 38. The actuating rod 39 can be rotated manually around its longitudinal axis either manually by means of the door handle or also by means of the electrically driven drive unit 26. This also forms the transmission element 30, which is connected to the electrically driven drive unit 26.

Depending on the design of the door lock 22, the provision of at least one door handle 42 can be dispensed with. In most cases, a door handle 42 is placed on the side of door leaf 6 facing the living area and on the opposite side—here in the area of the second door-leaf surface 15—a fixed doorknob 43 or a grip plate. Depending on the design of cover element 29, this doorknob or grip plate can be permanently connected to cover element 29 and/or subsequently to door leaf 6.

The access from the side facing away from the living area and the necessary unlocking of the lock latch and/or the unlocking of the lock bolt can be carried out in this exemplary embodiment and with doorknob 43 on the outside by means of the electrically driven drive unit 26 or also with a key and operation of the lock cylinder 28 with it. The opening of door leaf 6 from the living area side and the necessary unlocking of the lock latch and/or the lock bolt can be carried out by means of the electrically driven drive unit 26 or also by means of the door handle 42. The lock cylinder 28 can also be unlocked by means of the key.

The arrangement and/or design of the electrical power source 27, which is preferably designed as an electrical power storage device 32, the possible contactless electrical transmission device 34 and/or the electrical connection device 37 can also be carried out analogously, as has already been described in detail in FIGS. 1 and 2.

Since the drive assemblies 25 described above are each electrically powered embodiments, they can also be controlled by means of an operating control system, for example, and the individual adjustment steps can be set in motion in the desired drive direction by means of generated commands.

The generated control commands can be transmitted wired, wired and/or wireless. For example, the drive arrangement 25 can comprise a first communication unit 40 and a second communication unit 41 interacting with it. The exemplary embodiment shown in FIGS. 2 and 3 shows the communication units 40, 41 communicating on a wireless basis. The first communication unit 40 is at least designed to receive commands or signals generated by the second communication unit 41 and transmit them to the electrically driven drive unit 26 for their operation.

It should be noted that the individual communication units 40, 41 can be equipped with transmitting and/or receiving devices, an input terminal and, where applicable, also their own electrical power source 27, in particular, their own electrical power storage device 32. The second communication unit 41 shown here can be formed by a mobile phone, a smartphone, a remote control module or the like. However, a fixed input terminal, a card reader or the like could also be provided in order to be able to generate and forward and/or transmit the corresponding control command(s) or control signals. Furthermore, before generating commands and/or signals, the authorization to control the electrically driven drive unit 26 can be checked, as is well known.

Since these are known devices and/or means of control, they will not be discussed in more detail. The additional provision of the individual communication units 40, 41 can also be applied to the exemplary embodiment shown and described in FIG. 3.

Furthermore, it can be seen from the two FIGS. 2 and 3 that, on the side of the lock case 23 of the door lock 22 towards the first door-leaf surface 14 and the second door-leaf surface 15, there remains an installation space within the door leaf 6, the width or depth of which is available in the normal direction on the door-leaf surface 14 or 15 for the arrangement and reception of at least the electric drive unit 26. Depending on the width or depth of the installation space, the electrical power storage device 32 can also be arranged or accommodated within the lock case 23 on the side.

As already pointed out above, in FIGS. 4 to 6, for a better understanding and easier allocation of the component terms used for door lock 22, these are explained and described in detail on the basis of a lock with a multipoint-locking system.

In the exemplary embodiment shown, the door lock 22 comprises a main lock case 45 and at least one secondary lock case 46 arranged spaced away from it in the direction of the first longitudinal face side 17 of door leaf 6—two secondary lock cases 46 are provided here. If the door leaf 6 is upright, one above and one below. The main lock case 45 essentially corresponds to the component arrangement of the locking system 21, which was previously and generally referred to as lock case 23.

In the main lock case 45 or in the lock case 23, the locking and/or blocking mechanism 24 is again picked up or arranged, wherein the lock latch 47 described above and the lock bolt 48 are each shown in a position protruding from the main lock case 45. The term “lock latch” 47 and the lock bolt 48 are general designations, wherein these can also be referred to as the main lock latch and the main lock bolt when placed on or in the main lock case 45.

The cuff 49 extends from the main lock case 45 to at least one secondary lock case 46 and is used to attach the entire door lock 22 to door leaf 6. Each secondary lock case 46 contains at least one other lock block 48, which can also be referred to as a secondary lock bolt if it is arranged on the secondary lock case 46. It would also be possible to arrange at least one of your own further lock latch 47 at or in the secondary lock case 46, wherein this can then also be called a secondary lock latch. It would be possible to provide only the additional lock bolt 48 or only the additional lock latch 47 in the case of secondary lock case 46, wherein both can also be provided simultaneously. In order to pass on the adjustment movements from the main lock case 45 to the at least one secondary lock case 46, a drive rod 50, usually designed in the form of a flat profile, is provided. The drive rod 50 is stationary or the drive rods 50 have a drive connection with the locking and/or blocking mechanism 24 and are or will be relocated by means of this for the actuation of at least one secondary lock case 46.

In the area of the main lock case 45, there is a receptacle opening for the lock cylinder 28 (not shown here) as well as the lock follower 38 with the square opening for the actuating rod 39 of the door handle 42 connected to it. The receptacle opening intended to accommodate the lock cylinder 28 can be referred to as cylinder perforation 51, which passes through the main lock case 45 or the lock case 23 and is adapted to the cross-sectional shape of the lock cylinder 28. In the sectional view of FIG. 6, the door leaf 6 is still indicated in its design as a seamless door leaf 6 with its first longitudinal face side 17 in dashed lines.

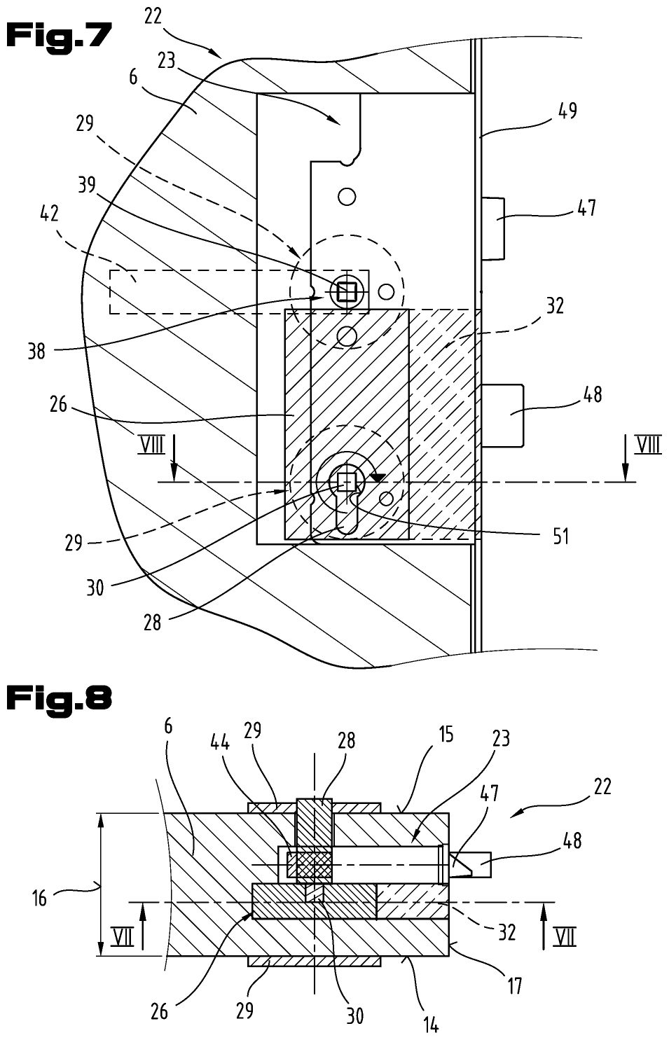

Possible examples of the arrangement of the electric drive unit 26 of the drive arrangement 25 with regard to the simple lock case 23 of the door lock 22 are shown and described in the following FIGS. 7 to 14. The basic structure and arrangement can be analogous to that described in FIGS. 1 to 3. In turn, the same reference numbers or component designations are used for identical parts as in the previous FIGS. 1 to 6. In order to avoid unnecessary repetition, reference is made to the detailed description in the preceding FIGS. 1 to 6.

The first exemplary embodiment in the two related FIGS. 7 and 8 shows the lock case 23 with its lock follower 38, the door handle 42 which is connected to it by means of the actuating rod 39 and the lock cylinder 28. The drive arrangement 25 indicates the electric drive unit 26, which is shown with shading for better recognizability and is connected to the lock cylinder 28. In addition to the electric drive unit 26, the electrical power storage device 32 can also be arranged, as indicated. This can also be or will be recorded at a different position within the door leaf 6. So-called rosettes, which are indicated by dashed lines in FIG. 7, can serve as cover elements 29. However, it would also be possible to provide and/or arrange at least one elongated plate.

Door leaf 6 indicated in FIG. 8 is seamless, wherein any other design is also possible. The lock case 23 and also at least the electric drive unit 26 are inserted into the door leaf 6 starting from the first longitudinal face side 17. This means that the receptacle recess, recess, insertion or receptacle opening for the electrically driven drive unit 26 can also extend over a greater depth into door leaf 6. In this case, it is not absolutely necessary to cover the entire surface of the electric drive unit 26 in the area of at least one of the door-leaf surfaces 14 or 15.

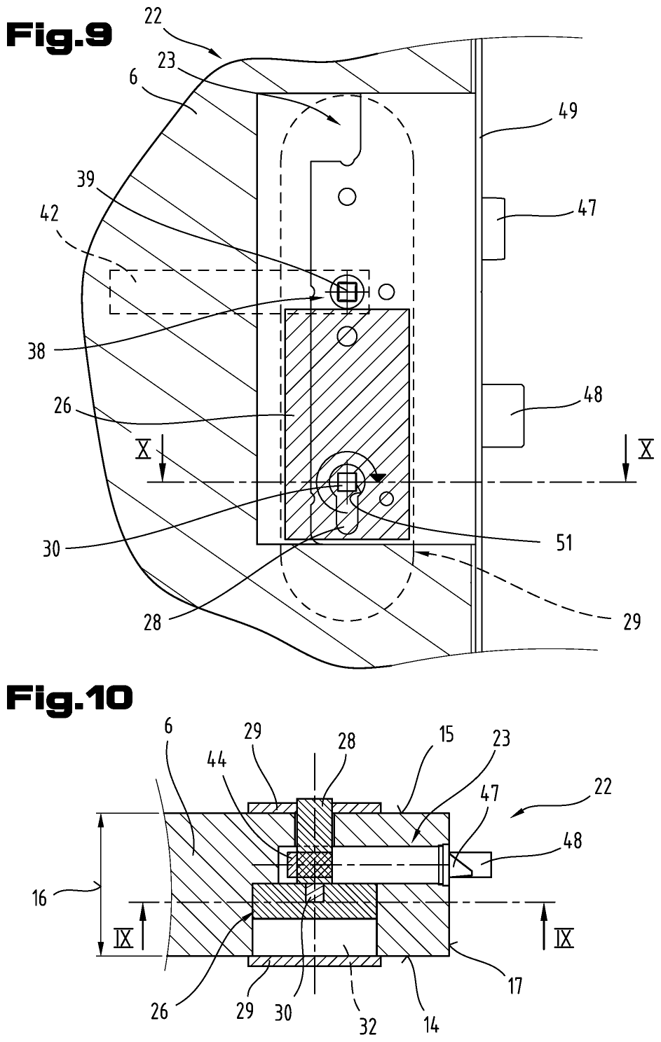

The second exemplary embodiment in the two related FIGS. 9 and 10 again shows the lock case 23 with its lock follower 38, the door handle 42 which is connected to it by means of the actuating rod 39 and the lock cylinder 28. The drive arrangement 25 indicates the electric drive unit 26, which is shown with shading for better recognizability and is connected to the lock cylinder 28.

Depending on the relative arrangement of the lock cylinder 28, the electric drive unit 26 is inserted into the door leaf 6 either from the first door-leaf surface 14 or the second door-leaf surface 15. Due to this arrangement of the receptacle recess, recess, insertion or receptacle opening for the electrically driven drive unit 26, the cover element 29 is to be designed as a so-called elongated plate in order to achieve a cover in the area of at least one of the door-leaf surfaces 14 or 15, wherein the cover element 29 is indicated in dashed lines in FIG. 9.

For its part, the electrical power storage device 32 can be installed in the door leaf 6 starting from the first longitudinal face side 17, as described above, or also from at least one of the door-leaf surfaces 14, 15 parallel to the electrically driven drive unit 26.

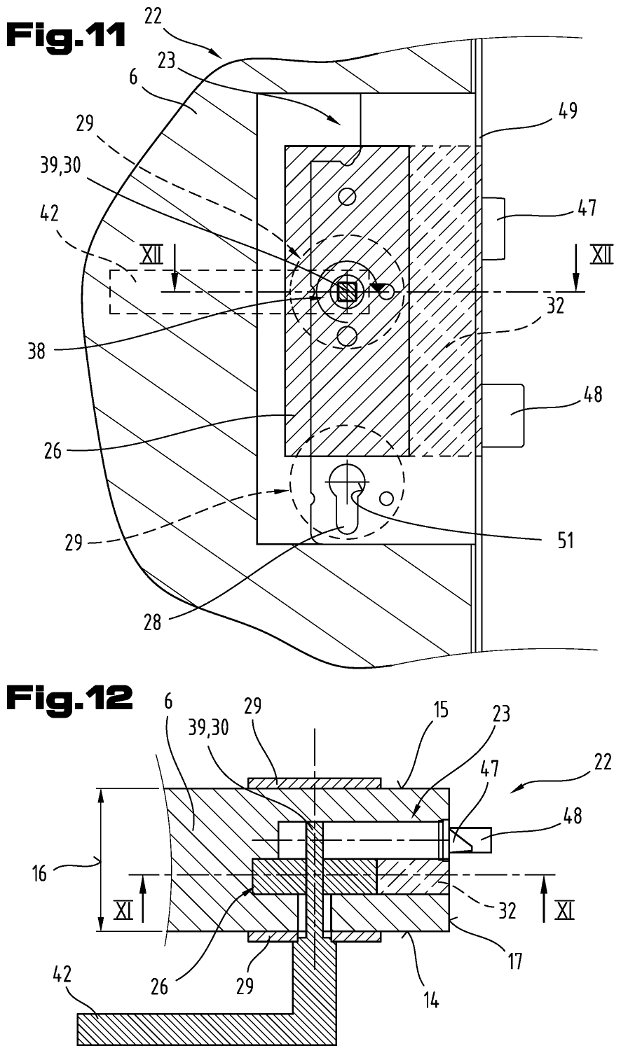

The third exemplary embodiment in the two related FIGS. 11 and 12 also shows the lock case 23 with its lock follower 38, the door handle 42 which is connected to it by means of the actuating rod 39 and the lock cylinder 28. The drive arrangement 25 indicates the electric drive unit 26, which is shown with shading for better recognizability and is here connected to the lock follower 38, in particular, by means of the actuating rod 39 as transmission element 30. With the exception of the transmission of the drive torque to the lock follower 38, this exemplary embodiment corresponds to that shown in FIGS. 7 and 8.

In addition to the electric drive unit 26, the electrical power storage device 32 can also be arranged, as indicated by dashed, shaded elements. This can also be or will be recorded at a different position within the door leaf 6. So-called rosettes can serve as cover elements 29. However, it would also be possible to provide and/or arrange at least one elongated plate.

The lock case 23 and also at least the electric drive unit 26 are inserted into the door leaf 6 starting from the first longitudinal face side 17. This means that the receptacle recess, recess, insertion or receptacle opening for the electrically driven drive unit 26 can also extend over a greater depth into door leaf 6. In this case, it is not absolutely necessary to cover the entire surface of the electric drive unit 26 in the area of at least one of the door-leaf surfaces 14 or 15.

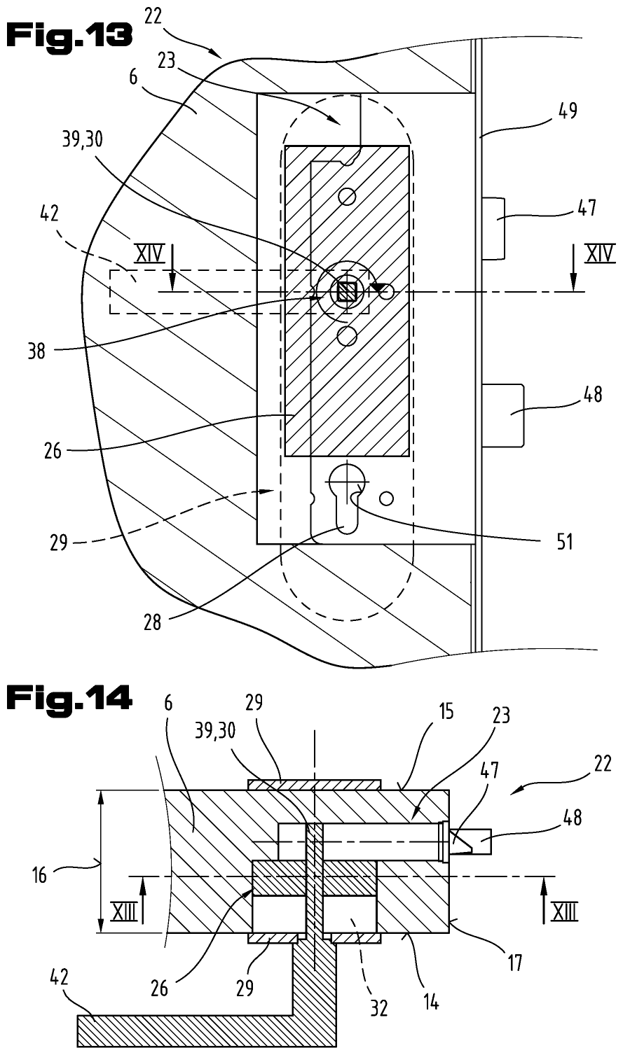

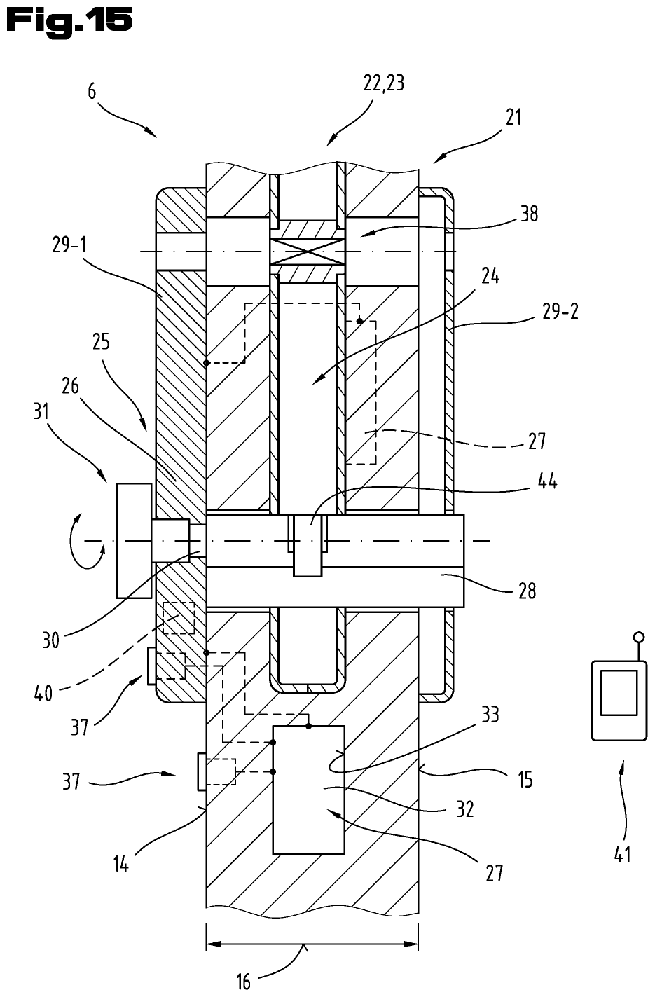

Finally, in the other two related FIGS. 13 and 14, a fourth exemplary embodiment is shown and described. In turn, the lock case 23 with its lock follower 38, the door handle 42, which is connected to it by means of the actuating rod 39, and the lock cylinder 28 are shown. The drive arrangement 25 indicates the electric drive unit 26, which is shown here with shading for better recognizability and is connected to the lock follower 38, in particular by means of the actuating rod 39 as transmission element 30. With the exception of the transfer of the drive torque to the lock follower 38, this exemplary embodiment corresponds to that shown in FIGS. 9 and 10.

Depending on the relative arrangement of the lock cylinder 28, the electric drive unit 26 is inserted into the door leaf 6 either from the first door-leaf surface 14 or the second door-leaf surface 15. Due to this arrangement of the receptacle recess, notch, insertion or receptacle opening for the electrically driven drive unit 26, the cover element 29 is to be designed as a so-called elongated plate in order to achieve a cover in the area of at least one of the door-leaf surfaces 14 or 15, wherein in FIG. 13 the cover element 29 is again indicated in dashed lines.

For its part, the electrical power storage device 32 (not shown here in more detail) can be installed in the door leaf 6 starting from the first longitudinal face side 17, as described above, or also from at least one of the door-leaf surfaces 14, 15 parallel to the electrically driven drive unit 26.

FIG. 15 shows a further and, where applicable, independent embodiment of the locking system 21 with its drive arrangement 25, wherein, in turn, the same reference numbers or component designations as in the preceding FIGS. 1 to 14 are used for identical parts. In order to avoid unnecessary repetition, reference is made to the detailed description in the preceding FIGS. 1 to 14.

This exemplary embodiment is similar to that which has already been described in more detail in FIGS. 2 and 7 to 10. The electric drive unit 26 is, in turn, also has a mechanical drive connection with the lock cylinder 28, wherein the latter is inserted in the lock case 23 and, for its part, is operatively connected to the locking and/or blocking mechanism 24 located in lock case 23. The difference is that the electric drive unit 26 is not located inside the door leaf 6 but can be arranged outside the door leaf 6 and preferably covered by one of the cover elements 29. Here, too, at least the electric drive unit 26 is also arranged to the side of the lock case 23, but in the area of one of the door-leaf surfaces 14 or 15. The electric drive unit 26 is either covered by one of the cover elements 29 or a housing of the drive unit 26 itself forms the cover element 29, wherein the drive mechanism or the drive components are also located directly on the door leaf 6 in a protected manner. This is indicated in FIG. 15 for the left cover element 29-1 with shading.

For example, it would be possible to mechanically couple the electric drive unit 26 with the lock cylinder 28 in a torque-proof manner by means of the transmission element 30 and to hold or attach it to one of the door-leaf surfaces 14 or 15. In the exemplary embodiment shown, the electric drive unit 26 is arranged on the inside of the living area in the area of the first door-leaf surfaces 14. Irrespective of this, it would also be possible to arrange at least the electric drive unit 26 on the side of the cover element 29 facing the door leaf 6 within it and, where applicable, to also hold or attach this to it. In both cases, a fixed and torque-proof connection must be formed either with the door leaf 6 or with the cover element 29. The cover element 29 is usually attached to door leaf 6 and positioned in a torque-proof manner. Furthermore, and independently of this, however, a housing of the electric drive unit 26 itself could be designed in the form of the cover element 29. This makes it possible to create a simple and cohesive group of components that forms both the cover element 29 as well as the electric drive unit 26. This makes it possible to create a slim and visually simple design, by means of which opening and/or locking operations of the door lock 22 can be carried out on command.

The electrical power storage device 32, the transmission device 34, the connection device 37, the door handle 42 and the actuating element 31 can be arranged and/or designed in the same way as described in detail in the previous figures. However, the same also applies to communication units 40 and 41. The actuating element 31 can in turn have a torque-proof connection by means of the electric drive unit 26, and the transmission element 30 can have a torque-proof drive connection with the lock cylinder 28.

For its part, the electrical power storage device 32 can be located in the previously described receptacle recess 33 within the door leaf 6 and/or also in the area on one of the door-leaf surfaces 14 and/or 15, but also covered by cover element 29.

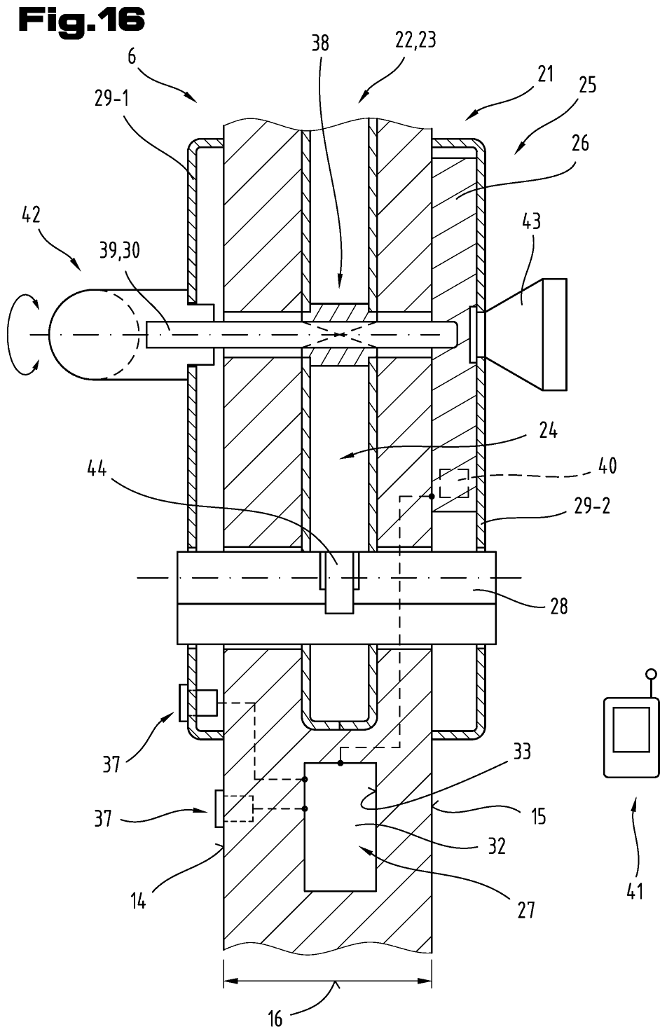

FIG. 16 shows a further and, where applicable, independent embodiment of the locking system 21 with its drive arrangement 25, wherein, in turn, the same reference numbers or component designations as in the preceding FIGS. 1 to 15 are used for identical parts. In order to avoid unnecessary repetition, reference is made to the detailed description in the preceding FIGS. 1 to 15.

This exemplary embodiment is similar to that already described in more detail in FIGS. 3 and 11 to 14. The electric drive unit 26 in turn has a mechanical drive connection or operative connection with the lock follower 38 by means of the actuating rod 39 designed as a transmission element 30 with the locking and/or blocking mechanism 24 of the door lock 22.

In this exemplary embodiment, as in the exemplary embodiment described in FIG. 15, it is also provided that the electric drive unit 26 is located outside the door leaf 6 and in the immediate area of one of its door-leaf surfaces 14 or 15. Here, too, at least the electric drive unit 26 is also arranged to the side of the lock case 23, but in the area of one of the door-leaf surfaces 14 or 15 and not within the door leaf 6. The electric drive unit 26 is either covered by one of the cover elements 29 or a housing of the drive unit 26 itself forms the cover element 29, wherein the drive mechanism or the drive components are also located directly on the door leaf 6 in a protected manner. If the housing of the drive unit 26 itself forms the cover element 29, a simple and coherent group of components can be created, which forms both the cover element 29 as well as the electric drive unit 26. This makes it possible to create a slim and visually simple design, by means of which opening and/or locking operations of the door lock 22 can be carried out on command.

For example, it would be possible to couple the electric drive unit 26 with the lock follower 38 mechanically and in a torque-proof manner by means of the transmission element 30 and to hold or attach it to one of the door-leaf surfaces 14 or 15. In the exemplary embodiment shown, the electric drive unit 26 is arranged on the side facing away from the living space in the area of the second door-leaf surfaces 15. Irrespective of this, it would also be possible to arrange at least the electric drive unit 26 on the side of the cover element 29 facing the door leaf 6 within it and, where applicable, to also hold or attach this to it. In both cases, a fixed and torque-proof connection must be formed either with the door leaf 6 or with the cover element 29. The cover element 29 is usually attached to door leaf 6 and positioned in a torque-proof manner.

The electrical power storage device 32, the transmission device 34, the connection device 37, the door handle 42 and the doorknob 43 can be arranged and/or designed in the same way, as has already been described in detail in the previous figures. However, the same also applies to communication units 40 and 41. If the actuating element 31 is provided, it can have a torque-proof drive connection with the lock cylinder 28 in a known way.

For its part, the electrical power storage device 32 can be located in the previously described receptacle recess 33 within the door leaf 6 and/or also in the area on one of the door-leaf surfaces 14 and/or 15, but also covered by cover element 29.

In the two exemplary embodiments described in FIGS. 15 and 16, the cover element 29 or the housing of the electric drive unit 26 can preferably be designed in the form of a so-called elongated plate. However, it would also be conceivable to train in the form of a rosette.

The exemplary embodiments show possible embodiment variants, wherein it should be noted at this point that the invention is not limited to the specifically presented embodiment variants of the same, but rather various combinations of the individual embodiment variants are also possible with each other and this possibility of variation lies in the skill of the person skilled in the art working in this technical field based on the doctrine of technical action via the present invention.

The scope of protection is determined by the claims. However, the description and drawings are to be taken into account for the interpretation of the claims. Individual features or combinations of features from the different exemplary embodiments shown and described can constitute independent inventive solutions in their own right. The problem underlying the stand-alone inventive solutions can be inferred from the description.

Ultimately, for the sake of good order, it should be pointed out that for a better understanding of the structure, elements were, in part, depicted to scale and/or enlarged and/or reduced.

### REFERENCE LIST

1 door assembly
2 wall opening
3 wall
4 door frame
5 door hinge
6 door leaf
7 lining board
8 decorative cladding element
9 rebate cladding element
10 first frame section
11 left frame section
12 right frame section
13 passage opening
14 first door-leaf surface
15 second door-leaf surface
16 door-leaf thickness
17 first longitudinal face side
18 second longitudinal face side
19 first transverse face side
20 second transverse face side
21 locking system
22 door lock
23 lock case
24 locking and/or blocking mechanism
25 drive arrangement
26 drive unit
27 power source
28 lock cylinder
29 cover element
30 transmission element
31 actuating element
32 electrical power storage device
33 receptacle recess
34 transmission device
35 transmission element
36 transmission element
37 connection device
38 lock follower
39 actuating rod
40 first communication unit
41 second communication unit
42 door handle
43 doorknob
44 actuating means
45 main lock case
46 secondary lock case
47 lock latch
48 lock bolt
49 cuff
50 drive rod
51 cylinder perforation

1. A door assembly for installation in or on a wall opening of a wall; the door assembly comprising:
a door frame,
at least one door leaf, which defines at least one door leaf, a first door-leaf surface and a second door-leaf surface spaced away from it in a door-leaf thickness, wherein the door leaf is comprehensively delimited by a first longitudinal face side, a second longitudinal face side, a first transverse face side and a second transverse face side, and wherein the door leaf is connected to the door frame in terms of synchronized movement, and
a locking system, the locking system comprising:
a door lock with a lock case and a locking and/or blocking mechanism, wherein the door lock is inserted into the door leaf in the area of the first longitudinal face side and held in position on it, and
a drive arrangement with an electrically driven drive unit and with an electrical power source, wherein the electrically driven drive unit is mechanically connected to the locking and/or blocking mechanism of the door lock,
the electrically driven drive unit is being located to the side of and immediately adjacent to the lock case in the direction of the door-leaf thickness.

2. A door assembly for installation in or on a wall opening a wall; the door assembly comprising:
a door frame,
at least one door leaf, which defines at least one door leaf, a first door-leaf surface and a second door-leaf surface spaced away from it in a door-leaf thickness, wherein the door leaf is comprehensively delimited by a first longitudinal face side, a second longitudinal face side, a first transverse face side and a second transverse face side, and wherein the door leaf is connected to the door frame in terms of synchronized movement, and
a locking system, the locking system comprising:
a door lock with a lock case and a locking and/or blocking mechanism, wherein the door lock is inserted into the door leaf in the area of the first longitudinal face side and held in position on it, and
a drive arrangement with an electrically driven drive unit and with an electrical power source, wherein the electrically driven drive unit is mechanically connected to the locking and/or blocking mechanism of the door lock,
the electrically driven drive unit being is arranged in the direction of the door-leaf thickness to the side of the lock case and in the area of one of the door-leaf surfaces on the door leaf.

3. The door assembly according to claim 1, wherein in that the electrically driven drive unit is held in a fixed position on the lock case.

4. The door assembly according to claim 1 wherein the electrically driven drive unit is held in the door leaf and its predominant part is arranged within it.

5. The door assembly according to claim 2, characterized in that the electrically driven drive unit is fixed to the door-leaf surface of the door leaf.

6. The door assembly according to claim 1, wherein the locking system comprises a lock cylinder, which lock cylinder is mounted in a cylinder perforation located in the lock case, and the electrically driven drive unit is mechanically driven via the lock cylinder with the locking and/or blocking mechanism of the door lock.

7. The door assembly according to claim 1, wherein the electrically driven drive unit has a mechanical drive connection with the locking and/or blocking mechanism of the door lock via a lock follower of the door lock.

8. The door assembly according to claim 1, wherein the electrically driven drive unit is covered by a cover element in the area of one of the door-leaf surfaces.

9. The door assembly according to claim 8, wherein the electrically driven drive unit is arranged within the cover element and held in a fixed position on it.

10. The door assembly according to claim 1, wherein the drive arrangement additionally comprises a manually operated actuating element, which actuating element is located on the side of the electrically driven drive unit facing away from the lock case and is mechanically connected to the locking and/or blocking mechanism of the door lock.

11. The door assembly according to claim 10, wherein the manually operated actuating element projects over the cover element on the side facing away from the lock case.

12. The door assembly according to claim 10, wherein the manually operated actuating element projects through the cover element.

13. The door assembly according to claim 1, wherein the electrical power source is designed as an electrical power storage device and the electrical power storage device is held in the door leaf.

14. The door assembly according to claim 13, wherein the electrical power storage device is held in a fixed position on the lock case.

15. The door assembly according to claim 13, wherein the door leaf comprises a receptacle recess in the area of its first longitudinal face side and the electrical power storage device is arranged in the receptacle recess.

16. The door assembly according to claim 1, wherein the locking system comprises a contactless electrical transmission device with a first transmission element and a second transmission element, and the first transmission element is arranged in the area of the first longitudinal face side of the door leaf and, when the door leaf is closed, the second transmission element is arranged in the area of a right or left frame section of the door frame located directly opposite the first longitudinal face side, and the first transmission element is connected in an electrically conductive manner to the electrical power storage device.

17. The door according to claim 1, wherein the locking system comprises an electrical connection device, which electrical connection device is arranged in the area of the first door-leaf surface and is connected in an electrically conductive manner to the electrical power storage device.

18. The door assembly according to claim 1, wherein the electrical power storage device is selected from the group consisting of: an accumulator, a battery, and a capacitor.

19. The door assembly according to claim 1, wherein the drive arrangement comprises a first communication unit and a second communication unit interacting with it, which first communication unit is at least designed to receive commands generated by the second communication unit and transmit them to the electrically driven drive unit for its operation.
